(19) United States
(12) Patent Application Publication
(10) Pub. No.: US 2018/0245382 A1
(43) Pub. Date: Aug. 30, 2018

(54) Locking Bolt that Can Be Installed Without Threads

(71) Applicant: Dieter Ramsauer, Schwelm (DE)

(72) Inventor: Dieter Ramsauer, Schwelm (DE)

(21) Appl. No.: 15/751,692

(22) PCT Filed: Nov. 4, 2015
(86) PCT No.: PCT/EP2015/002207

§ 371 Date: Feb. 9, 2018

(30) Foreign Application Priority Data
Aug. 10, 2015 (DE) 20 2015 005 678.4

(51) Int. Cl. E05C 1/00; E05C 1/12; E05B 1/00

(52) U.S. Cl. CPC E05C 1/002; E05B 1/00; E05C 1/12

(57) ABSTRACT

A locking bolt or hinge bolt with a guide sleeve that can be secured to a machine part such as a sheet metal wall or door leaf, a locking pin being guided therein so as to be axially displaceable against spring force, and with a handle which is axially guided by the outer surface of the guide sleeve, wherein the guide sleeve has a head constituting an outer shoulder by which the guide sleeve is fastened to the machine part.

The present application claims priority from PCT Patent Application No. PCT/EP2015/002207 filed on Nov. 4, 2015, which claims priority from German Priority Application No. 20 2015 005 678.4 filed on Aug. 10, 2015, the disclosures of which are incorporated herein by reference in their entirety.

### FIELD OF THE INVENTION

The invention is directed to a locking bolt and a hinge bolt with a guide sleeve which can be secured to a machine part such as a sheet metal wall or door leaf, a locking pin or a locking bolt being guided therein so as to be axially displaceable against spring force, and with a handle which is axially guided by the outer surface of the guide sleeve.

A locking bolt of this type is already known from EP 2175093A2.

It is disadvantageous in the prior art that an intermediate part with a recess must be provided for securing the guide sleeve to the machine part or to a thin wall or door leaf; further, the guide sleeve must be provided with an external thread for mounting by which the locking bolt must be screwed into a machine part, which requires the arrangement of a threaded bore hole and also complicates mounting.

### SUMMARY OF THE INVENTION

The object of the invention is to further develop the known locking bolt so that it does not have these drawbacks and so that a further constructional form is achieved.

This object is met in that the guide sleeve is provided with a head constituting an outer shoulder by which the guide sleeve is fastened to the machine part.

Further applications are realized by means of these steps, and mounting is facilitated because the guide sleeve need no longer be inconveniently screwed on and screwed into a threaded bore hole of the machine part.

According to a further development, the guide sleeve also supports an intermediate ring so as to be axially displaceable, which guide sleeve resiliently contacts the handle on the one hand and the machine part, such as thin sheet metal, on the other hand.

According to another further development, the back end of the locking bolt carries a retaining ring in a ring groove, which retaining ring limits the axial movement of the locking pin through the guide sleeve on the one hand and through the handle on the other hand.

According to yet another embodiment form, the guide sleeve comprises two parts and can accordingly be mounted even more easily.

Instead of the retaining ring, spring legs emerging from the handle can also snap into the ring groove, and the handle is secured to the machine part, for example, by two head screws or by spring pressure.

According to another embodiment form, the head of the guide sleeve can be received in a countersink or bend of the machine part or of the sheet metal.

According to another embodiment form, the guide sleeve has a head with two protruding rings which are arranged at a distance from one another and which receive the machine part or the sheet metal between them.

The locking bolt with its head can be arranged in the guide sleeve, while the other end of the locking bolt is held with a nut or with a retaining ring which contacts the handle.

The invention will be described in more detail in the following with reference to drawings.

### BRIEF DESCRIPTION OF THE DRAWINGS

FIG. 1A shows an exploded view of the individual parts of the locking bolt in a first embodiment form.

FIG. 1B shows a side view of the locking bolt according to the invention mounted in a thin wall.

FIG. 1C shows a side view of the unmounted locking bolt.

FIG. 1D shows the locking bolt according to FIG. 1C, but with a differently adjusted guide sleeve.

FIG. 1E shows a sectional view in axial direction through the arrangement in FIG. 1D.

FIGS. 2A to 2E show corresponding views of another embodiment form.

FIG. 2F shows a sectional view through the arrangement according to FIG. 1D.

FIG. 3A shows a further embodiment form of the locking bolt in a side view with broken-out portion and fastening by means of two head screws.

FIG. 3B shows a sectional view through the embodiment form shown in FIG. 3A.

FIG. 3C shows a side view of the locking bolt.

FIG. 4 shows a side view of a further embodiment form.

FIG. 5 shows a side view of a locking bolt in combination with the thin wall, in which the thin wall of the machine part is bent.

FIG. 6A shows a side view of the three parts to be mounted.

FIG. 6B shows prior to mounting in a thin sheet metal.

FIGS. 7A to 7C show before and after mounting.

FIGS. 8A and 8B show in the alignment position and detachment position.

FIGS. 9A to 9C show locking bolt with inserted sleeve head with nut and with retaining spring secured in groove.

FIGS. 10A to 10F show a further embodiment form which serves as hinge.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

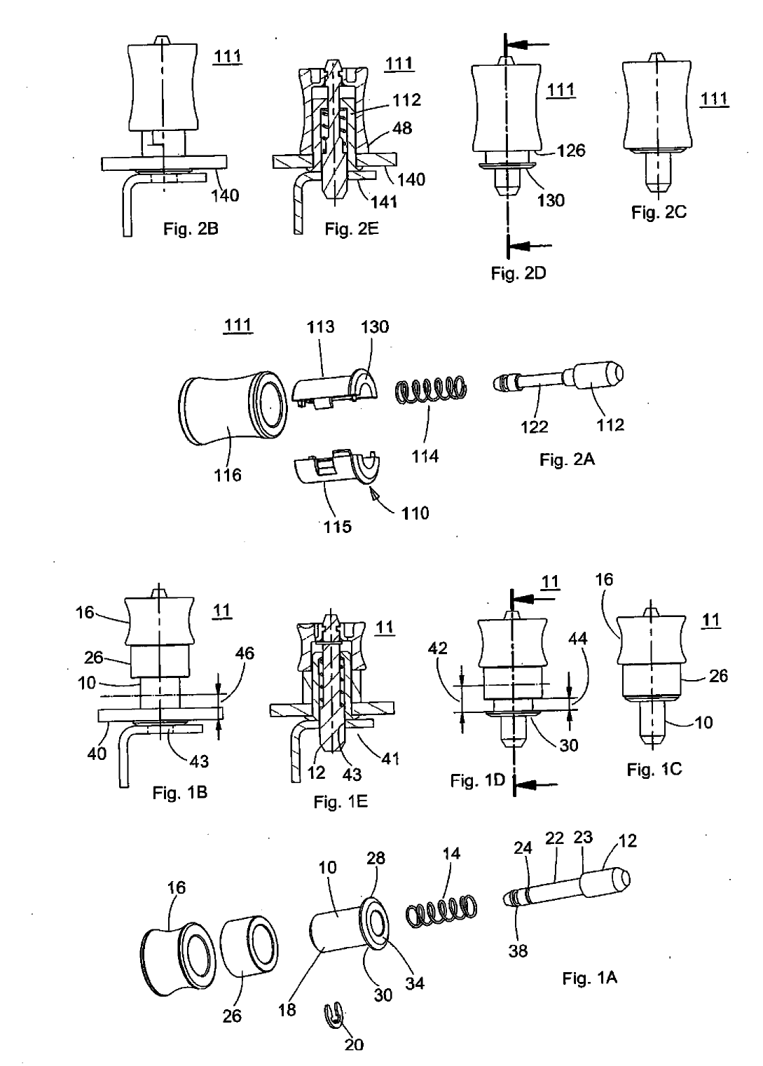

FIG. 1A shows an exploded view of the individual parts of the locking bolt 12 in a first embodiment form. As can be seen from FIG. 1, the locking bolt comprises a guide sleeve 10 in which a locking pin or locking bolt 12 is guided so as to be axially displaceable against the force of the spring 14 and comprises a handle 16 which is axially guided by the outer surface of the guide sleeve 10.

The back end of the bolt 12 is provided with a ring groove 24 for a retaining ring 20 which prevents the locking bolt 12 from sliding out of the guide sleeve 10. There is further provided an intermediate piece 26 which is axially displaceably guided on the outer surface 18 of the guide sleeve 10.

FIG. 1E is an axial sectional view showing the construction and the application according to FIGS. 1A to 1D.

According to the invention, the guide sleeve 10 also has an intermediate ring 26. The intermediate ring 26 is axially displaceable on the guide sleeve. The intermediate piece 26 contacts the handle 16 on the one side and the head 28 on the other side, the outer shoulder 30 of the latter supports the intermediate piece 26.

FIG. 1B shows the locking bolt or locking pin 12 mounted in an aligning arrangement 11 and the handle 16 which contacts the shoulder 28 of the locking bolt 12 through spring pressure of spring 14 and is pushed in direction of the thin wall 40 as is shown in FIG. 1E.

While the guide sleeve in the prior art has an external thread by which it is screwed into a corresponding threaded bore hole in the thin wall 40 and then secured by a lock nut, the mounting is carried out in the following manner with the locking bolt 12 according to the invention:

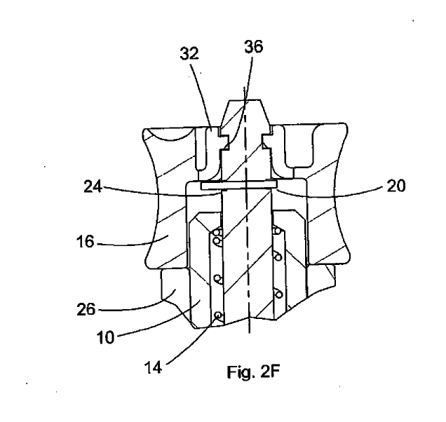

In the embodiment form according to FIGS. 1A to 1E and 2F:
1. The spring 14 is placed on the thinner, back end 22 of the locking bolt 12 until the end of the spring contacts the shoulder 23 formed by an enlargement of the diameter of the locking bolt 12 at the front end.
2. The guide sleeve is placed on the spring.
3. The retaining ring 20 is pushed laterally into the groove 24 at the back end of the locking bolt. The back end of the guide sleeve 10 is inserted depending on the thickness 46 of the machine part or wall 40 (FIG. 1B).
4. An optional intermediate piece 26 of a suitable axial length is slid on until the head 28 of the guide sleeve 10 contacts the machine part or wall 40.
5. The handle 16 is slid onto the end of this guide sleeve.
6. Axial pressure is applied to the handle until spring legs 32 emerging from the interior of the handle snap into a further ring groove (FIG. 2F) arranged closer to the end of the locking bolt.
7. The machine part, such as a thin wall 40, 140, carrying the aligning device 19, 119 is arranged and the further machine part 41, 141 is aligned with respect to the first-mentioned machine part 40, 140 by inserting the locking pin 112 into the aligning bore hole 43.

In the embodiment form according to FIGS. 2A to 2F, there are fewer assembly steps. The guide sleeve is clipped together with the spring 114; in particular the arrangement of the lock washer is dispensed with. The two-part guide sleeve 110, 210 can be assembled by clipping together the two parts 113, 115 around the back end 122 of the locking pin 112 so that that wall 140 extends between head 130 of the two parts 113, 115 of the guide sleeve 110 that are clipped together and supporting surface 48 of handle 116 which is tensioned by the helical compression spring 114.

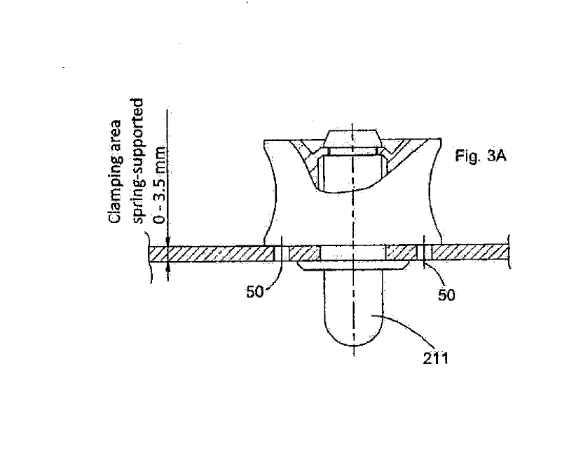

FIG. 3A shows the embodiment form of a locking pin 211 which has a flexible clamping area. The handle contacts the wall under spring loading.

The embodiment forms according to FIGS. 3B to 3C have a locking pin 311 which is supported by a spring ring 336. The handle 316 is supported by spring legs 332 which lock into a ring groove 338.

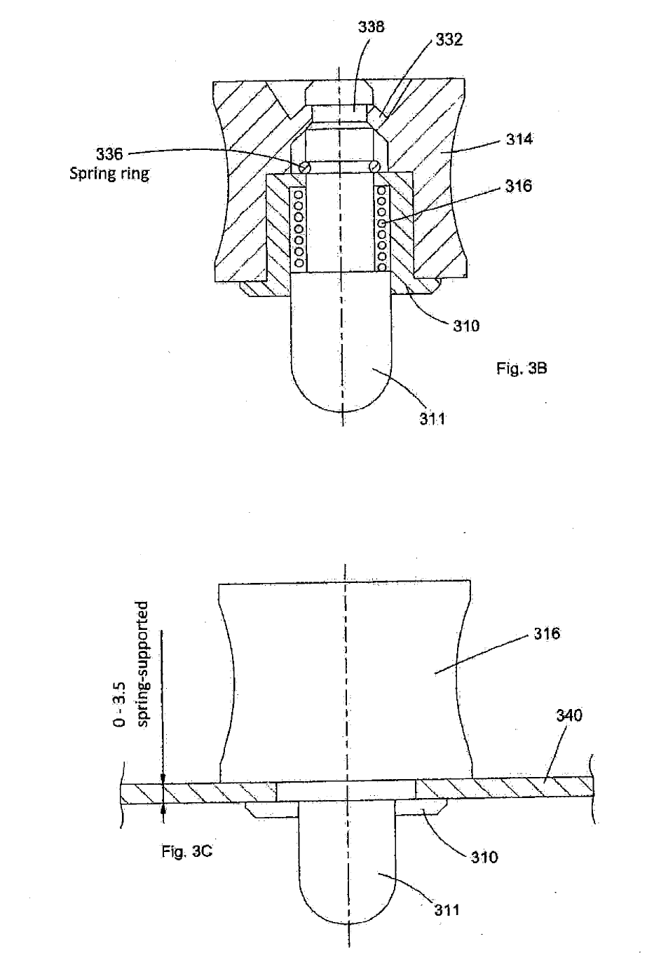

FIG. 4 shows an embodiment form in which the guide sleeve 410 is supported on both sides of the thin wall 440.

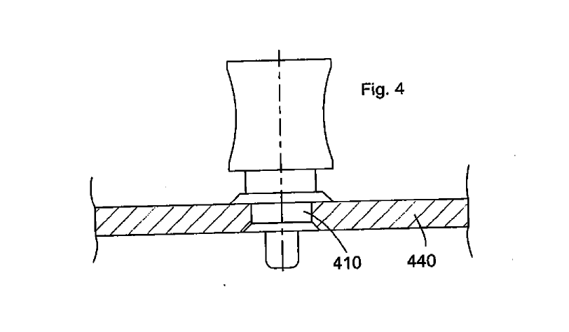

Instead of this, the locking bolt in FIG. 5 is characterized in that the head of the guide sleeve 510 can be received in a countersink or bent portion 49 of the machine part or of the sheet metal 540.

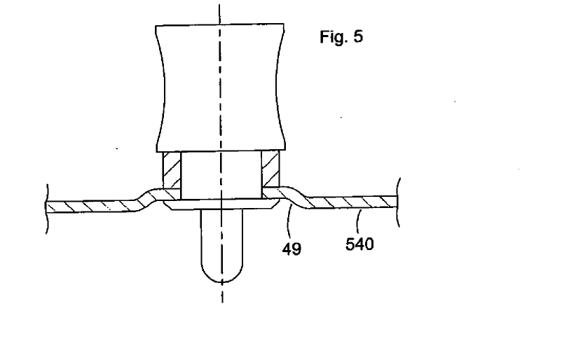

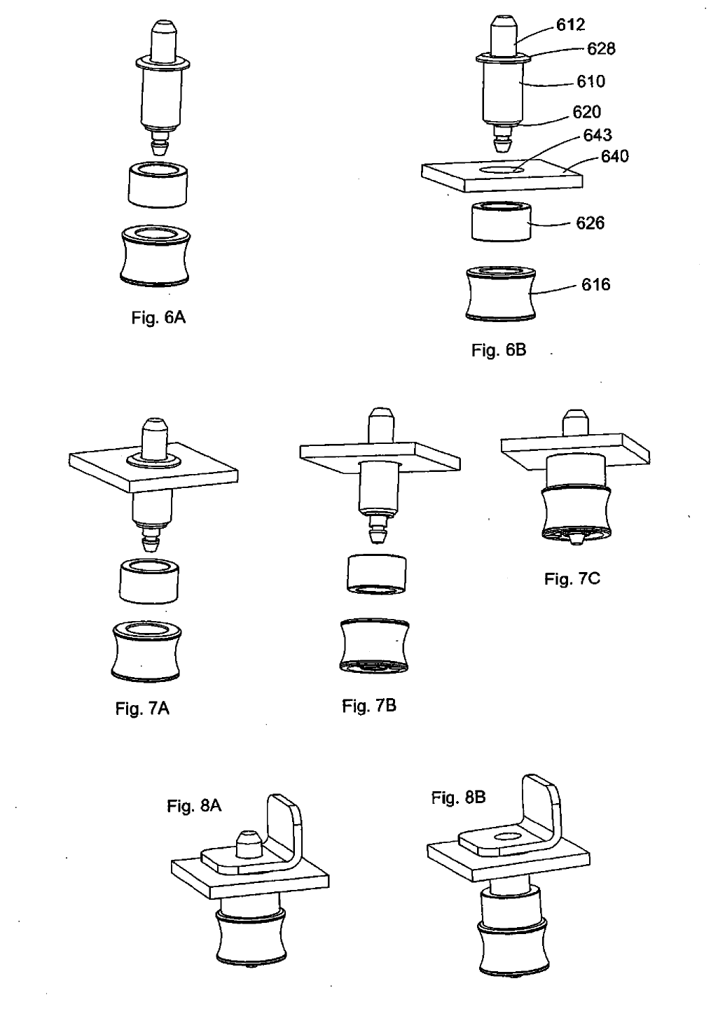

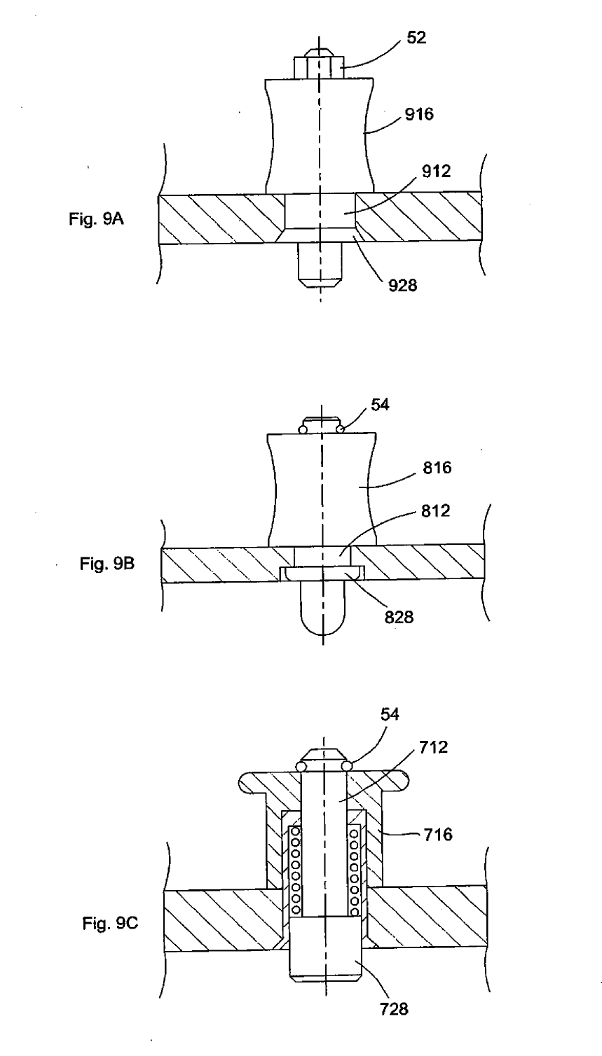

FIGS. 6A, 6B, 7A and 7C and 8A and 8B show embodiment forms which are characterized in that the guide sleeve 610 has a head 628 with two rings 628, 620 which are arranged at a distance from one another and which receive between them the machine part or sheet metal 640.

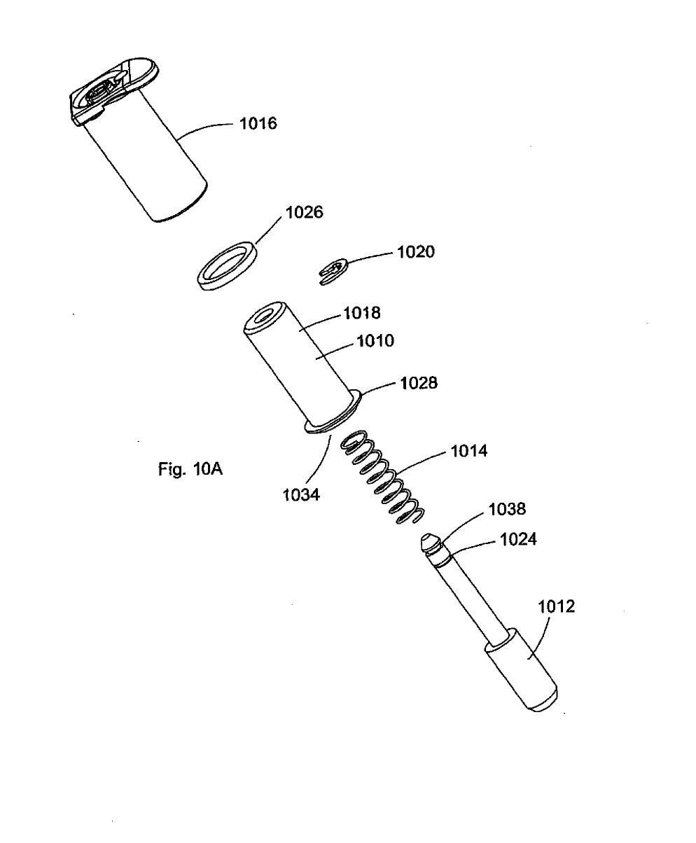

FIGS. 9A, 9B and 9C show that the locking pin 712, 812, 912 is arranged with its head 728 in the guide sleeve 710, while the other end of the locking pin 712 is held with a nut 52 or with a retaining ring 54 which is supported on the handle 716, 816, 916.

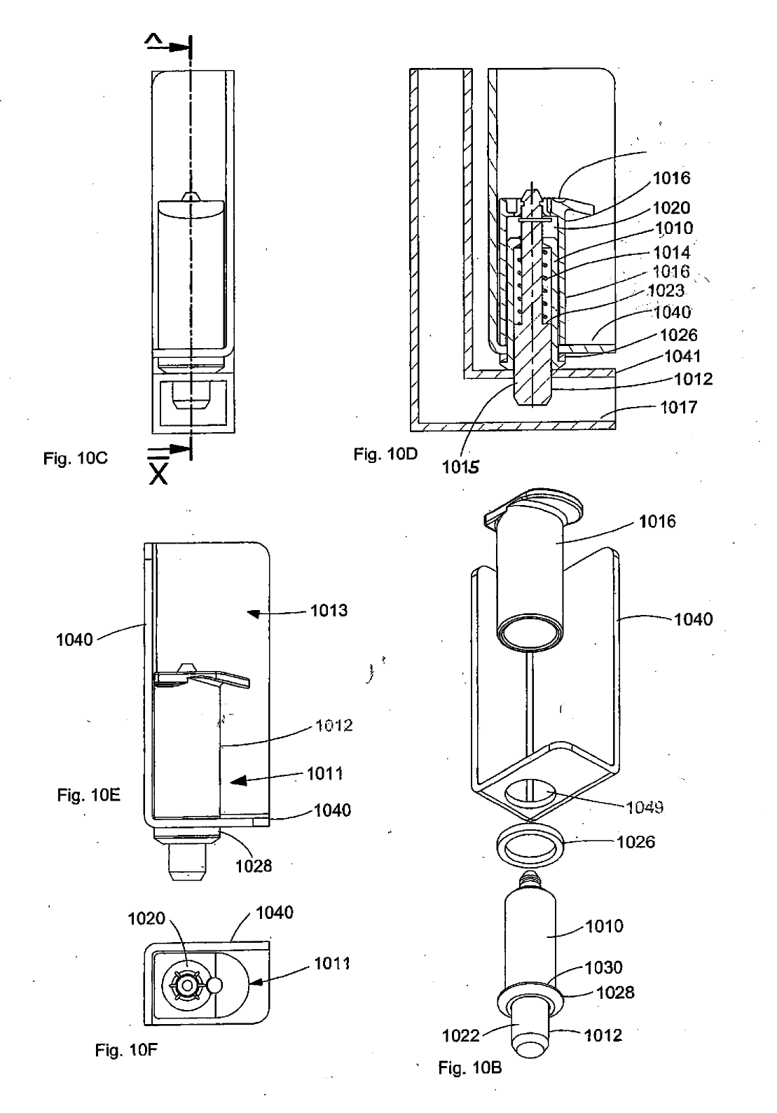

FIG. 10A shows an exploded view of the individual parts of the locking bolt 1012 for a mounting hinge as a further embodiment form. As can be seen from FIG. 10A, the locking bolt hinge comprises a guide sleeve 1010, in which a locking pin or locking bolt 1012 is guided so as to be displaceable axially against the forces of spring 1014, and a handle 1016 which is axially guided by the outer surface of the guide sleeve 1010 and held laterally by the bevel such that it cannot rotate.

The back end of the bolt 1012 is provided with a ring groove 1024 for a retaining ring 1020 which prevents the locking bolt 1012 from sliding out of the guide sleeve 1010. Further, an optional intermediate piece 1026 is provided which is axially displaceably guided on the outer surface 1018 of the guide sleeve 1010.

FIG. 10D is an axial sectional view along section line XX in FIG. 10C showing the construction and application according to FIGS. 10A to 10F.

According to the invention, the guide sleeve 1010 also has an intermediate ring 1026. The intermediate ring 1026 is axially displaceable on the guide sleeve 1010. The intermediate piece 1026 contacts the door leaf 1040 on the one side and the head 1028 on the other side, and the outer shoulder 1030 of the latter supports the intermediate piece 1026.

FIGS. 10E and 10F show the locking bolt or locking pin 1012 mounted in a hinge arrangement 1011 and the handle 1016 which contacts the shoulder 1023 of the locking bolt 1012 through spring pressure of spring 1014 and is pushed in direction of the thin wall 1040 of the sheet metal cabinet door 1013 as is shown in FIG. 10D. The locking bolt extends into a bearing aperture 1015 of the door frame 1017.

While the guide sleeve in the prior art has an external thread by which it is screwed into a corresponding threaded bore hole in the thin wall 1040 and then secured by a locking nut, mounting with the locking bolt 1012 according to the invention in accordance with FIGS. 10A to 10F is carried out in the following manner:
1. The spring 1014 is placed on the thinner, back end of the locking bolt 1012 until the end of the spring contacts the shoulder 1023 formed by an enlargement 1022 of the diameter of the locking bolt 1012 at the front end.
2. The guide sleeve 1010 is placed on the spring 1014.
3. The retaining ring 1020 is pushed laterally into the groove 1024 at the back end of the locking bolt 1012. The back end of the guide sleeve 1010 is inserted depending on the thickness of the machine part (door leaf) or wall 1040 (FIG. 10D).
4. An optional intermediate piece 1026 of a suitable axial length is slid on until the head 1028 of the guide sleeve 1010 contacts the machine part or wall 1040.
5. The handle 1016 is slid onto the end of this guide sleeve 1010.
6. Axial pressure is applied to the handle until spring legs 1032 emerging from the interior of the handle snap into a further ring groove (FIG. 10D) arranged closer to the end of the locking bolt.
7. The door having two hinge devices 1011 is positioned with respect to the door frame 1017 in the upper and lower corners of the frame, respectively, by inserting the locking pin 1012 into the aligning bore hole.

### COMMERCIAL APPLICABILITY

The invention is commercially applicable in a switch cabinet construction.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

### LIST OF REFERENCE NUMERALS

10, 110, 1010 guide sleeve
11, 111, 1011 aligning arrangement
12, 112, 1012 locking bolt
113 part of the guide sleeve
14, 1014 spring
115 part of the guide sleeve
16, 1016 handle
18, 1018 outer surface
20, 1020 retaining ring
22, 1022 back end of the locking bolt
23, 1023 shoulder
24, 1024 groove
26, 1026 intermediate piece
28, 1028 head
30, 1030 inner shoulder
32, 1032 spring leg
34, 1034 outer shoulder
36, 1036 ring groove for locking washer
38, 1038 ring groove for spring legs
40, 140, 1040 machine part, thin wall, door leaf
41, 1041 component part to be fastened
42, 1042 distance
43, 1042 aligning bore hole
44 distance
46 distance
48 stabilizing support
49 bent portion
50 screw
52 nut
54 spring support

1. A locking bolt or hinge bolt comprising:
a guide sleeve configured to be secured to a machine part;
a locking pin configured to be guided in the guide sleeve so as to be axially displaceable against a spring force; and
a handle configured to be axially guided by the outer surface of the guide sleeve;
wherein the guide sleeve has a head constituting an outer shoulder by which head the guide sleeve is fastened to the machine part.

2. The locking bolt or hinge bolt according to claim 1:
wherein the guide sleeve supports an intermediate ring as to be axially displaceable; and
wherein one end of the guide sleeve is configured to contact the handle and an opposite end of the guide sleeve is configured to the machine part.

3. The locking bolt or hinge bolt according to claim 1:
wherein a back end of the locking bolt carries a retaining ring in a first ring groove, which retaining ring limits an axial movement of the locking pin through the guide sleeve and through the handle.

4. The locking bolt or hinge bolt according to claim 1:
wherein the guide sleeve comprises two parts.

5. The locking bolt or hinge bolt according to claim 1:
wherein the handle comprises springs configured to snap into a second ring groove of the locking pin; and
wherein the handle is secured to the machine part by two head screws or by spring pressure.

6. The locking bolt or hinge bolt according to claim 2:
wherein the head of the guide sleeve is configured to be received in a countersink or bend of the machine part.

7. The locking bolt or hinge bolt according to claim 1:
wherein the head of the guide sleeve has two rings that are arranged at a distance from one another and which receive the machine part between them.

8. The locking bolt or hinge bolt according to claim 1:
wherein, when the locking pin is arranged in the guide sleeve, one end of the locking pin is held with a nut or with a retaining ring which contacts the handle.

9. The locking bolt or hinge bolt according to claim 1:
wherein the handle has a head that is adapted to a bevel area of the machine part.

10. The locking bolt or hinge bolt according to claim 9:
wherein the head of the handle has legs protruding over a cross section of locking pin.

11. The locking bolt or hinge bolt according to claim 8:
wherein the head of the guide sleeve is integral with the guide sleeve.

12. The locking bolt or hinge bolt according to claim 9:
wherein the head of the handle is not round.

13. The locking bolt or hinge bolt according to claim 1:
wherein the guide sleeve has two ring grooves, one for a retaining ring and one for spring legs.
